(19) United States
(12) Patent Application Publication
(10) Pub. No.: US 2026/0024978 A1
(43) Pub. Date: Jan. 22, 2026

(54) ELECTRICAL CONNECTION UNIT

(71) Applicant: YAZAKI CORPORATION, Tokyo (JP)

(72) Inventors: Kazuhiro Naito, Kakegawa-shi (JP); Kazuki Kobayashi, Kakegawa-shi (JP); Hirokuni Kurashiki, Susono-shi (JP)

(21) Appl. No.: 19/263,428

(22) Filed: Jul. 8, 2025

(30) Foreign Application Priority Data
Jul. 16, 2024 (JP) 2024-113236
Jan. 6, 2025 (JP) 2025-001196

(51) Int. Cl. H02G 5/10; B60R 16/023; H01R 9/22; H02G 5/08

(52) U.S. Cl. CPC H02G 5/10; B60R 16/0239; H01R 9/226; H02G 5/08; H01R 2201/26

(57) ABSTRACT

An electrical connection unit includes a first bus bar, a second bus bar, and a first heat transfer member thermally connecting the first bus bar to the second bus bar.

### BACKGROUND OF THE INVENTION

### Field of the Invention

Embodiments of the present invention relate to an electrical connection unit.

Priority is claimed on Japanese Patent Application No. 2024-113236 filed in Japan on Jul. 16, 2024, and Japanese Patent Application No. 2025-001196 filed in Japan on Jan. 6, 2025, the contents of which are incorporated herein by reference.

### Description of the Related Art

An electrical connection unit having a housing that accommodates electronic components and a bus bar attached to the housing in a standing posture is known.

### PRIOR ART DOCUMENT

### Patent Document

Patent Document 1: Japanese Unexamined Patent Application, First Publication No. 2024-037492

### SUMMARY OF THE INVENTION

Incidentally, it is expected to improve a heat dissipation property of an electrical connection unit.

An embodiment provides an electrical connection unit capable of improving a heat dissipation property.

An electrical connection unit according to an embodiment includes a first bus bar, a second bus bar, and a first heat transfer member thermally connecting the first bus bar to the second bus bar.

According to one embodiment, it is possible to improve a heat dissipation property of an electrical connection unit.

### BRIEF DESCRIPTION OF THE DRAWINGS

FIG. 1 is a cross-sectional view illustrating an electrical connection unit of a first embodiment;

FIG. 2 is an enlarged view of a section II in FIG. 1.

FIG. 3 is a partially exploded perspective view of a main body in the section II in FIG. 1.

FIG. 4 is a plan view of a main body in the section II in FIG. 1.

FIG. 5 is an end view taken along line IV-IV in FIG. 2.

FIG. 6 is a perspective view for describing the action of the main body according to the first embodiment.

FIG. 7 is an end view taken along line VII-VII in FIG. 6.

FIG. 8 is a perspective view for describing the action of the main body according to the first embodiment.

FIG. 9 is an end view taken along line IX-IX in FIG. 8.

FIG. 10 is an end view of a main body according to a fifth modification example of the first embodiment, taken along line IV-IV in FIG. 2.

FIG. 11 is an end view of a main body according to a sixth modification example of the first embodiment, taken along line IV-IV in FIG. 2.

FIG. 12 is a perspective view illustrating part of an electrical connection unit in seventh and eighth modification examples of the first embodiment.

FIG. 13 is an end view of an electrical connection unit according to the seventh modification example of the first embodiment, taken along line XIII-XIII in FIG. 12.

FIG. 14 is an end view of an electrical connection unit according to the eighth modification example of the first embodiment, taken along line XIII-XIII in FIG. 12.

FIG. 15 is a plan view illustrating part of an electrical connection unit of a second embodiment.

FIG. 16 is a cross-sectional view taken along line XVI-XVI in FIG. 15.

FIG. 17 is a plan view illustrating part of an electrical connection unit of a third embodiment.

FIG. 18 is a cross-sectional view taken along line XVIII-XVIII in FIG. 17.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. Note that the constitution described below does not limit the scope of the embodiment.

In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “accommodation” is not limited to a case where the entire component is accommodated, and may include a case where only part of the component is accommodated (a state in which the remaining part of the component protrudes). The term “facing” indicates that virtual projection images of two target objects overlap each other when viewed from a specific direction. That is, the term “facing” is not limited to a case where two target objects directly face each other, and may include a case where two target objects face each other in a state in which another member exists between the two target objects. “Parallel”, “orthogonal”, or “the same” may include “substantially parallel”, “substantially orthogonal”, or “substantially the same”, respectively. “Sheet-shaped” or “sheet” is not limited to a member having a thickness of 1 mm or more, and a member (so-called a film) having a thickness of less than 1 mm can also be used.

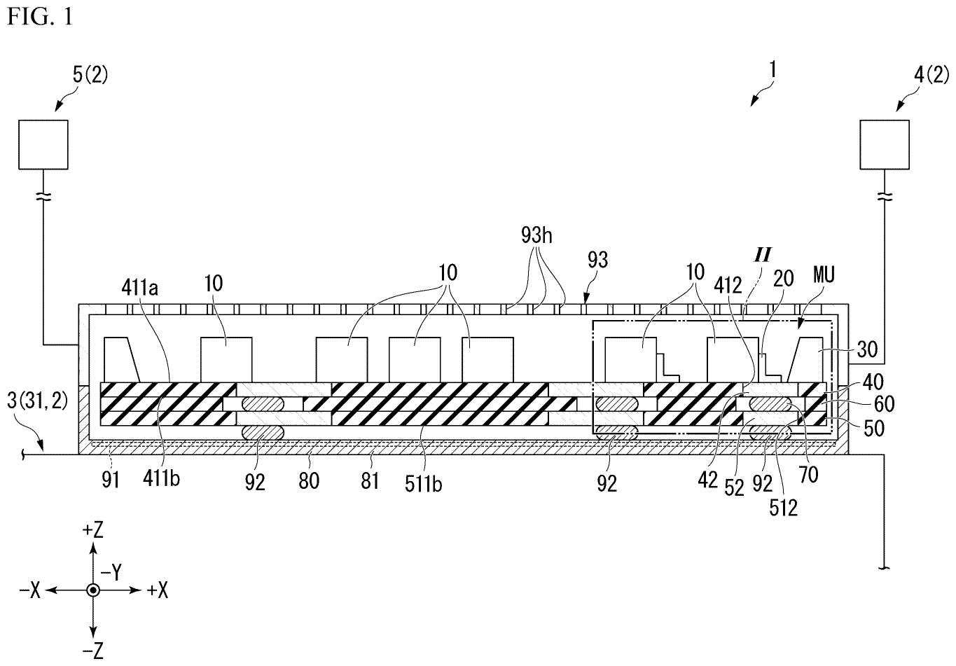

In the present disclosure, a +X direction, a −X direction, a +Y direction, a −Y direction, a +Z direction, and a −Z direction are defined as follows. The X direction is one direction in a plane along a metal plate 80 that will be described later. The +X direction is one side in the X direction. The −X direction is a direction opposite to the +X direction. Hereinafter, in a case where the +X direction and the −X direction are not distinguished, the directions will be simply referred to as “X direction”. The Y direction is a direction intersecting (for example, orthogonal to) the X direction in a plane along the metal plate 80 that will be described later. The +Y direction is one side in the Y direction. The −Y direction is a direction opposite to the +Y direction. Hereinafter, in a case where the +Y direction and the −Y direction are not distinguished, the directions will be simply referred to as “Y direction”. The +Z direction and the −Z direction are directions intersecting (for example, orthogonal to) the X direction and the Y direction. The +Z direction is a direction from the metal plate 80 that will be described later toward a main body MU (see FIG. 1). The −Z direction is a direction opposite to the +Z direction. Hereinafter, in a case where the +Z direction and the −Z direction are not distinguished, the directions will be simply referred to as “Z direction”. The Z direction is an example of a “first direction”. The X direction is an example of a “second direction”. The “second direction” is not limited to the X direction, and may be the Y direction or other directions.

Hereinafter, in a case where the X direction and the Y direction are not distinguished, the directions may be referred to as “horizontal direction”. Hereinafter, the Z direction may be referred to as “vertical direction”. Hereinafter, the +Z direction side may be referred to as “upper”, and the −Z direction side may be referred to as “lower”. However, these expressions are expressions for convenience of description, and do not limit a gravity direction of an electrical connection unit 1 (an installation posture the electrical connection unit 1).

### A. First Embodiment

### A1. Constitution of Electrical Connection Unit

The electrical connection unit 1 is, for example, an in-vehicle device mounted on a vehicle such as an electric vehicle (EV), a hybrid electric vehicle (HEV), or a plug-in hybrid electric vehicle (PHEV). The electrical connection unit 1 is connected to a plurality of external devices 2 present outside. The electrical connection unit 1 relays connection between the plurality of external devices 2. For example, the external devices 2 may include a battery pack 3, a load 4, and a charger 5. The battery pack 3 is mounted on a vehicle. The battery pack 3 includes a plurality of batteries 31. The load 4 is a device including an inverter or the like for driving a motor of a vehicle driven by using power stored in the battery pack 3. The charger 5 is a device for supplying power for charging the battery pack 3. The electrical connection unit 1 may be referred to as an “electrical connection box” or a “junction box”, for example. However, the electrical connection unit 1 is not limited to a box-shaped device.

The electrical connection unit 1 includes, for example, a main body MU, a metal plate 80, an insulating sheet 91, a plurality of heat transfer members 92, and an insulating cover 93.

In a first operation mode, out of a bus bar 42 and a bus bar 52 that will be described later, the electrical connection unit 1 can cause a current (first current) flowing only to the bus bar 42 to flow. For example, the electrical connection unit 1 may be capable of causing a current (second current) flowing only to the bus bar 52 to flow out of the bus bar 42 and the bus bar 52 by switching a plurality of relays included in a plurality of electronic components 10 that will be described later. For example, the first operation mode may be a charging mode in which the bus bar 42 operates as an energization line during charging and the bus bar 52 operates as a non-energization line during charging in which power is stored in the battery pack 3 from the charger 5 via the electrical connection unit 1. For example, the first current may be a charging current from the charger 5 to the battery pack 3.

During a second operation mode, the electrical connection unit 1 can cause a current to flow only to the bus bar 52 out of the bus bar 42 and the bus bar 52 that will be described later. For example, the electrical connection unit 1 may be capable of causing a current to flow only to the bus bar 52 out of the bus bar 42 and the bus bar 52 by switching a plurality of relays included in a plurality of electronic components 10 that will be described later. For example, the second operation mode may be a vehicle traveling mode in which the bus bar 52 operates as an energization line during traveling and the bus bar 42 operates as a non-energization line in vehicle traveling in which power is supplied from the battery pack 3 to the load 4 via the electrical connection unit 1. For example, the second current may be a load current from the battery pack 3 to the load 4.

### A2. Main Body

First, the main body MU will be described.

The main body MU is a portion that performs main functions (for example, switching of electrical connection states and overcurrent protection) of the electrical connection unit 1.

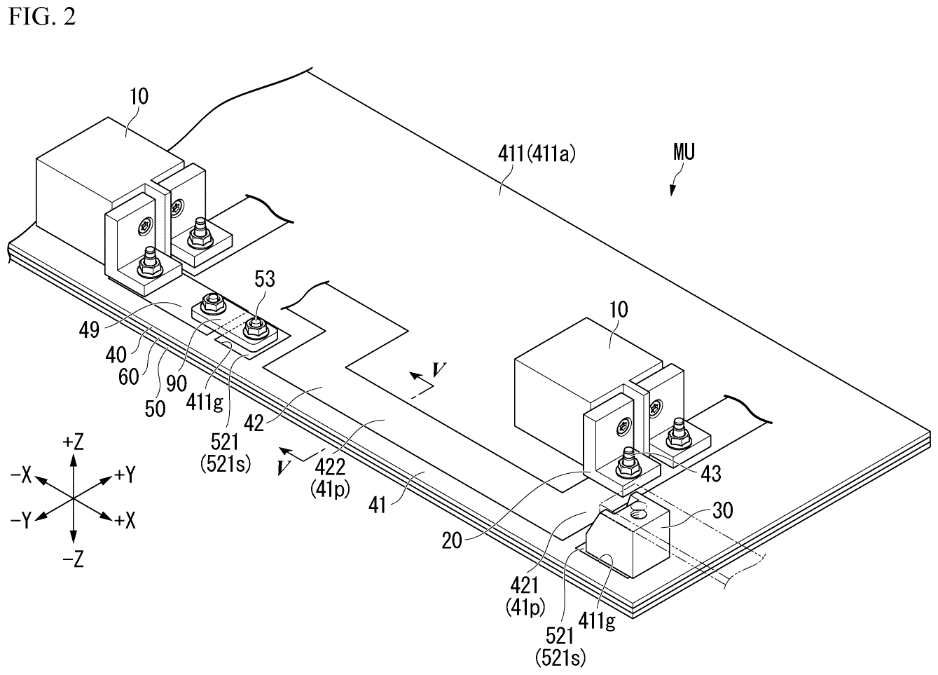

As illustrated in FIGS. 1 and 2, the main body MU includes, for example, a plurality of electronic components 10, a connection component 20 for component connection, a connection component 30 for load connection, a routing board 40, a routing board 50, an intermediate board 60, a heat transfer member 70, and a connection component 90 for bus bar connection. The connection components 20 and 30 are members forming an energization path in the vertical direction. The connection components 20 and 30 may be referred to as “vertical routing members”.

### A3. Electronic Component

First, the electronic component 10 will be described.

The electronic component 10 is an electronic component mounted according to a function required for the main body MU. The electronic component 10 is, for example, a connector, a fuse, a relay (for example, a mechanical relay or a semiconductor relay), a capacitor, a branch component, any of various sensors (for example, a current sensor or a voltage sensor), an electronic control unit, or an electronic component unit in which two or more of these are unitized. Note that the type of the electronic component 10 is not limited to the above example. For example, the electronic component 10 may be, for example, a heat generating component that generates heat when energized.

### A4. Connection Component for Component Connection

The connection component 20 is a component that electrically connects the electronic component 10 to the main body MU. The connection component 20 forms part of an energization path in the main body MU. In the present embodiment, the connection component 20 is a component that electrically connects the electronic component 10 to the routing board 40. The connection component 20 is made of a metal (for example, copper or a copper alloy).

### A5. Connection Component for External Device Connection

The connection component 30 is a component that electrically connects a wiring such as a bus bar connected to the external device 2 to the main body MU. In the present embodiment, the connection component 30 electrically connects a wiring such as a bus bar connected to the load 4 to the routing board 50. The connection component 30 is made of a metal (for example, copper or a copper alloy).

### A6. Connection Component for Bus Bar Connection

Next, the connection component 90 for bus bar connection will be described.

The connection component 90 is a component that electrically connects the bus bar of the main body MU to the bus bar. In the present embodiment, the bus bar of the routing board 40 and the bus bar of the routing board 50 are electrically connected. The connection component 90 is made of a metal (for example, copper or a copper alloy).

### A7. First Routing Board

Next, the routing board 40 will be described.

The routing board 40 is a member that forms at least part of an energization path between the electronic components 10 and/or at least part of an energization path between the electronic components 10 and the external devices 2 and/or at least part of an energization path between the external devices 2. In the present disclosure, the “routing board” indicates a board-type routing structure. The “board type” indicates a plate shape along one plane when viewed as a whole regardless of a fine shape. In the present disclosure, the “plate shape” is not limited to a completely flat shape, and may include a case where a fixing structure, a rib, or the like protruding in the Z direction is partially present. In the present embodiment, the routing board 40 has a plate shape formed in the X direction and the Y direction.

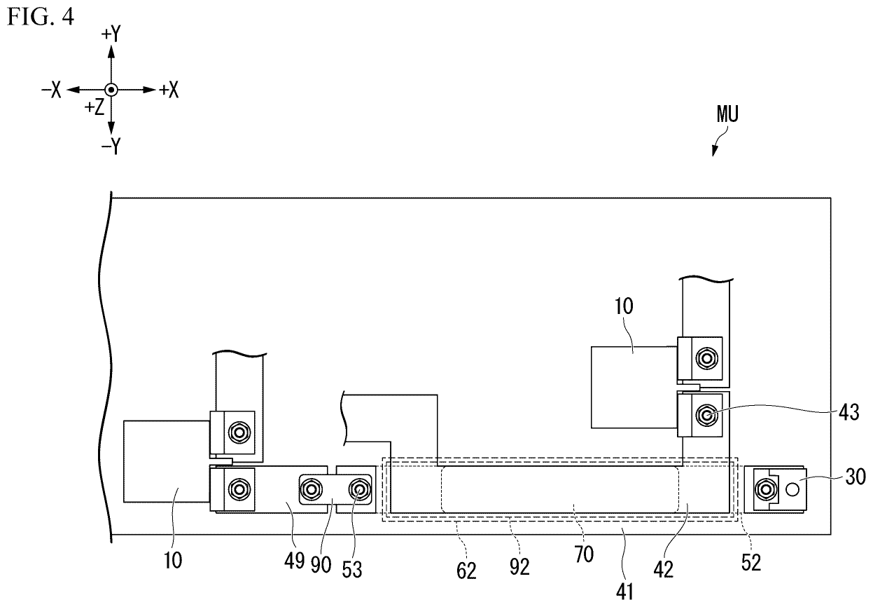

As illustrated in FIGS. 2 to 4, the routing board 40 includes, for example, a base plate 41, a bus bar 42, and another bus bar 49. In the present embodiment, the base plate 41 and the bus bar 42 are integrated through insert molding. For example, the routing board 40 is formed as a single member by insert-molding the bus bar 42 with the base plate 41. That is, the bus bar 42 is integrated with the base plate 41 without using a fastening member such as a screw or a bolt. Note that the routing board 40 may be formed by another structure instead of the insert molding. The routing board 40 is an example of a “first routing board”.

### (First Base Member)

The base plate 41 is a holding member that holds the bus bars 42. The base plate 41 is made of, for example, synthetic resin and has an insulating property. For example, the base plate 41 may hold the bus bar 42 and the bus bar 49 integrally. In this case, the base plate 41 electrically insulates the bus bar 42 from the bus bar 49. The base plate 41 is an example of a “first base member”. The base plate 41 has, for example, a flat surface portion 411.

The flat surface portion 411 is a portion formed in a plate shape in the base plate 41. The flat surface portion 411 has a plate shape formed in the horizontal direction. The flat surface portion 411 forms a main portion of the base plate 41. The flat surface portion 411 forms a base portion (insulating base portion) of the base plate 41. In the present embodiment, the flat surface portion 411 extends over the entire width of the base plate 41 in the X direction and over the entire width of the base plate 41 in the Y direction.

The flat surface portion 411 has a first surface 411a and a second surface 411b. The first surface 411a is a surface directed in the +Z direction. The first surface 411a is a flat surface provided in the horizontal direction. The first surface 411a faces the plurality of electronic components 10 and faces the insulating cover 93 (see FIG. 1) of the electrical connection unit 1. The second surface 411b is located on the side opposite to the first surface 411a. The second surface 411b is a surface directed in the −Z direction. The second surface 411b is a flat surface provided in the horizontal direction. The second surface 411b faces the metal plate 80 (see FIG. 1) via the intermediate board 60, the heat transfer member 70, the routing board 50, the plurality of heat transfer members 92, the insulating sheet 91, and the like. A thickness direction (plate thickness direction) of the flat surface portion 411 is the Z direction.

The flat surface portion 411 has, for example, an accommodation portion 412 in which the bus bar 42 is accommodated. The accommodation portion 412 is, for example, a through-hole penetrating the flat surface portion 411 from the first surface 411a to the second surface 411b in the Z direction. Note that the accommodation portion 412 may be a recess provided on the first surface 411a or the second surface 411b of the flat surface portion 411 and recessed in the Z direction, instead of a through-hole. Each accommodation portion 412 has an outer shape corresponding to the shape of the bus bar 42 to be accommodated when viewed from the Z direction. The flat surface portion 411 is an example of a “first flat surface portion”.

The flat surface portion 411 has a pair of openings 411g. The pair of openings 411g penetrates from the first surface 411a to the second surface 411b. For example, the pair of openings 411g may be separated from each other in the X direction. For example, each opening 411g may have a rectangular shape when viewed from the Z direction.

### (First Bus Bar)

The bus bar 42 is a routing member (electrical connection member) included in the routing board 40. The bus bar 42 is, for example, a routing member for electrically connecting the plurality of electronic components 10 and the plurality of connection components 20, 30, and 90. The bus bar 42 is made of a metal (for example, copper or a copper alloy) and has conductivity. The bus bar 42 includes portions disposed on the same plane. The bus bar 42 is held by the flat surface portion 411 of the base plate 41. The bus bar 42 is an example of a “first bus bar”.

At least part of each bus bar 42 has a plate shape formed in the horizontal direction. At least part of the bus bar 42 is accommodated in the accommodation portion 412 and extends along the flat surface portion 411. That is, at least part of the bus bar 42 extends along the first surface 411a of the flat surface portion 411. At least part of the bus bar 42 extends in the horizontal direction in the accommodation portion 412. In the present embodiment, the bus bar 42 has a plate shape formed in the horizontal direction over the entire bus bar 42. The bus bar 42 is accommodated in the accommodation portion 412 over the entire length of the bus bar 42 and extends along the flat surface portion 411.

The bus bar 42 includes, for example, a connection portion 421 and an extending portion 422. The connection portion 421 is a portion in contact with one connection component 20. The connection portion 421 is connected to one connection component 20 connected to the electronic component 10 so that one electronic component 10 and the bus bar 42 are electrically connected. The connection portion 421 is a portion of the bus bar 42 overlapping the connection component 20 when viewed from the Z direction. The connection portion 421 is adjacent to the connection component 20 in the Z direction and is connected to the connection component 20 from the Z direction. For example, the connection portion 421 and the connection component 20 may be fastened via a fastening member 43.

The extending portion 422 extends from the connection portion 421 in the X direction or the Y direction. The extending portion 422 continuously extends from the connection portion 421 in the XY plane. For example, the extending portion 422 may extend between a pair of openings 411g separated in the X direction up to the front of each opening 411g in the X direction.

In the present embodiment, the connection portion 421 and the extending portion 422 have a plate shape formed in the horizontal direction. In the present embodiment, the bus bar 42 is accommodated in the accommodation portion 412 at least over the connection portion 421 and the extending portion 422 and extends along the flat surface portion 411.

### (Other Bus Bar)

The other bus bar 49 may also have the same constitution as the bus bar 42. In addition, the other bus bar 49 may also be provided on the base plate 41 similarly to the bus bar 42. The other bus bar 49 may be connected to another electronic component 10 different from the plurality of electronic components 10 to which the bus bar 42 is connected.

### A8. Second Routing Board

Next, the routing board 50 will be described.

The routing board 50 is a member that forms at least part of an energization path between the electronic components 10 and/or at least part of an energization path between the electronic components 10 and the external devices 2 and/or at least part of an energization path between the external devices 2. In the present embodiment, the routing board 50 has a plate shape formed in the X direction and the Y direction.

The routing board 50 includes, for example, a base plate 51 and a bus bar 52. In the present embodiment, the base plate 51 and the bus bar 52 are integrated through insert molding. For example, the routing board 50 is formed as a single member by insert-molding the bus bar 52 with the base plate 51. That is, the bus bar 52 is integrated with the base plate 51 without using a fastening member such as a screw or a bolt. Note that the routing board 50 may be formed by another structure instead of the insert molding. The routing board 50 is an example of a “second routing board”.

### (Second Base Member)

The base plate 51 is a holding member that holds the bus bars 52. The base plate 51 is made of, for example, a synthetic resin and has an insulating property. The base plate 51 is an example of a “second base member”. The base plate 51 has, for example, a flat surface portion 511.

The flat surface portion 511 is a portion formed in a plate shape in the base plate 51. The flat surface portion 511 has a plate shape formed in the horizontal direction. The flat surface portion 511 forms a main portion of the base plate 51. The flat surface portion 511 forms a base portion (insulating base portion) of the base plate 51. In the present embodiment, the flat surface portion 511 extends over the entire width of the base plate 51 in the X direction and over the entire width of the base plate 51 in the Y direction.

The flat surface portion 511 has a third surface 511a and a fourth surface 511b. The third surface 511a is a surface directed in the +Z direction. The third surface 511a is a flat surface provided in the horizontal direction. The third surface 511a faces the second surface 411b. The fourth surface 511b is located on the side opposite to the third surface 511a. The fourth surface 511b is a surface directed in the −Z direction. The fourth surface 511b is a flat surface provided in the horizontal direction. The fourth surface 511b faces the metal plate 80 (see FIG. 1) via the plurality of heat transfer members 92, the insulating sheet 91, and the like. A thickness direction (plate thickness direction) of the flat surface portion 511 is the Z direction. The third surface 511a of the flat surface portion 511 is provided with a gap between the third surface 511a and the second surface 411b of the flat surface portion 411.

The flat surface portion 511 has, for example, an accommodation portion 512 in which the bus bar 52 is accommodated. The accommodation portion 512 is, for example, a through-hole penetrating the flat surface portion 511 from the third surface 511a to the fourth surface 511b in the Z direction. Note that the accommodation portion 512 may be a recess provided on the third surface 511a or the fourth surface 511b of the flat surface portion 511 and recessed in the Z direction, instead of a through-hole. The accommodation portion 512 has an outer shape corresponding to the shape of the bus bar 52 to be accommodated when viewed from the Z direction. The flat surface portion 511 is an example of a “second flat surface portion”.

### (Second Bus Bar)

The bus bar 52 is a routing member (electrical connection member) included in the routing board 50. The bus bar 52 is a routing member for electrically connecting each of the plurality of connection components 30 and 90. The bus bar 52 includes a pair of connection portions 521 and an extending portion 522. The bus bar 52 is made of a metal (for example, copper or a copper alloy) and has conductivity. The bus bar 52 is held by the flat surface portion 511 of the base plate 51. The bus bar 52 is an example of a “second bus bar”.

The extending portion 522 extends between the pair of connection portions 521. The extending portion 522 is continuous to the pair of connection portions 521. The extending portion 522 is integrally formed with the pair of connection portions 521. At least part of the extending portion 522 has a plate shape formed in the horizontal direction. At least part of the extending portion 522 is accommodated in the accommodation portion 512 and extends along the flat surface portion 511. That is, at least part of each extending portion 522 extends along the third surface 511a of the flat surface portion 511. At least part of each of the extending portion 522 extends in the horizontal direction in the accommodation portion 512. In the present embodiment, the extending portion 522 has a plate shape formed in the horizontal direction over the entire extending portion 522. The extending portion 522 is accommodated in the accommodation portion 512 over the entire length of the extending portion 522 and extends along the flat surface portion 511.

The pair of connection portions 521 are located apart from each other in the X direction. The connection portion on the −X direction side of the pair of connection portions 521 is located at an end of the extending portion 522 on the −X direction side. The connection portion on the +X direction side of the pair of connection portions 521 is located at an end of the extending portion 522 on the +X direction side. Each connection portion 521 rises and extends in the +Z direction from an end of the extending portion 522. Each of the connection portions 521 is further bent in the X direction from the tip rising and extending, and extends to a side away from the extending portion 522. For example, each connection portion 521 may have a rectangular shape when viewed from the Z direction.

The pair of connection portions 521 are provided at positions corresponding to the pair of openings 411g. The connection portion 521 on the −X direction side of the pair of connection portions 521 is provided in the opening 411g on the −X direction side of the pair of openings 411g. The connection portion 521 of +X direction side of the pair of connection portions 521 is provided in the opening 411g on the +X direction side of the pair of openings 411g.

Each of the connection portions 521 has a connection surface 521s that is a flat surface provided in the horizontal direction on the +Z direction side. For example, the connection surface 521s may have a rectangular shape when viewed from the Z direction. For example, each of the connection portions 521 may extend in the opening 411g such that the connection surface 521s is flush with the first surface 411a.

The connection surface 521s of the connection portion 521 side on the −X direction side of the pair of connection portions 521 is electrically connected to the portion of the connection component 90 on the +X direction side. In this case, for example, the connection portion 521 may be fastened and connected to the connection component 90 via a fastening member 53 such that the connection surface 521s is in contact with the flat surface of the connection component 90 on the −Z direction side. The bus bar 49 and the bus bar 52 are electrically connected via the connection component 90.

The connection surface 521s of the connection portion 521 side on the +X direction side of the pair of connection portions 521 is electrically connected to the connection component 30. In this case, for example, the connection portion 521 may be fastened and connected to the connection component 30 such that the connection surface 521s is in contact with the flat surface of the connection component 30 on the −Z direction side. The load 4 and the bus bar 52 are electrically connected via the connection component 30.

### A9. Intermediate Board

Next, the intermediate board 60 will be described.

The intermediate board 60 is a member for disposing the heat transfer member 70 between the bus bars 42 and 52. In the present embodiment, the intermediate board 60 has a plate shape formed in the X direction and the Y direction. The intermediate board 60 has the same plate thickness in the Z direction as the thickness in the Z direction of the heat transfer member 70, in which the heat transfer member 70 is sandwiched between the bus bar 42 and the bus bar 52 and closely fixed to the bus bar 42 and the bus bar 52.

The intermediate board 60 is made of, for example, a synthetic resin and has an insulating property. The intermediate board 60 is an example of an “intermediate member”. The intermediate board 60 has, for example, a flat surface portion 61.

The flat surface portion 61 is a portion formed in a plate shape in the intermediate board 60. The flat surface portion 61 has a plate shape formed in the horizontal direction. The flat surface portion 61 forms a main portion of the intermediate board 60. The flat surface portion 61 forms a base portion (insulating base portion) of the intermediate board 60. In the present embodiment, the flat surface portion 61 extends over the entire width of the intermediate board 60 in the X direction and over the entire width of the intermediate board 60 in the Y direction. A thickness direction (plate thickness direction) of the flat surface portion 61 is the Z direction.

The flat surface portion 61 has a fifth surface 61a and a sixth surface 61b. The fifth surface 61a is a surface directed in the +Z direction. The fifth surface 61a is a flat surface provided in the horizontal direction. The fifth surface 61a faces the second surface 411b. For example, the fifth surface 61a may be in surface contact with the second surface 411b. The sixth surface 61b is located on the side opposite to the fifth surface 61a. The sixth surface 61b is a surface directed in the −Z direction. The sixth surface 61b is a flat surface provided in the horizontal direction. The sixth surface 61b faces the third surface 511a. For example, the sixth surface 61b may be in surface contact with the third surface 511a.

The flat surface portion 61 includes, for example, an accommodation portion 62 in which the heat transfer member 70 is accommodated. The accommodation portion 62 is, for example, a through-hole penetrating the flat surface portion 61 from the fifth surface 61a to the sixth surface 61b in the Z direction. Note that the accommodation portion 62 may be a recess provided on the fifth surface 61a or the sixth surface 61b of the flat surface portion 61 and recessed in the Z direction, instead of a through-hole. The accommodation portion 62 has an outer shape corresponding to the shape of the heat transfer member 70 to be accommodated when viewed from the Z direction. The accommodation portion 62 overlaps at least part of a portion where the bus bar 42 and the bus bar 52 overlap when viewed from the Z direction. For example, the accommodation portion 62 may overlap at least part of a portion where the extending portion 422 and the extending portion 522 overlap when viewed from the Z direction. For example, the width of the accommodation portion 62 in the Y direction may be slightly larger than the width of the portion where the extending portion 422 and the extending portion 522 overlap each other in the Y direction. For example, the length of the accommodation portion 62 in the X direction may be slightly larger than the length of the portion where the extending portion 422 and the extending portion 522 overlap each other in the X direction. For example, when viewed from the Z direction, the center position of the accommodation portion 62 in the Y direction may coincide with the center position of the portion where the extending portion 422 and the extending portion 522 overlap in the Y direction. For example, the accommodation portion 62 may have the same thickness in the Z direction as the thickness in the Z direction of the heat transfer member 70, in which the heat transfer member 70 is sandwiched between the bus bar 42 and the bus bar 52 and closely fixed to the bus bar 42 and the bus bar 52.

### A10. First Heat Transfer Member

Next, the heat transfer member 70 will be described.

The heat transfer member 70 is a member for transferring heat between the bus bar 42 and the bus bar 52. For example, the heat transfer member 70 may be a member for transferring heat (Joule heat) generated by the bus bar 42 itself when the bus bar 42 is energized, to the bus bar 52. For example, the heat transfer member 70 may be a member for transferring heat (Joule heat) generated by the bus bar 52 itself when the bus bar 52 is energized, to the bus bar 42. For example, the heat transfer member 70 may be a member for transferring heat generated by the electronic component 10 when the electronic component 10 is energized, to the bus bar 52 via the bus bar 42. The heat transfer member 70 is, for example, a heat transfer sheet (for example, a thermally conductive silicone sheet) having elasticity. The heat transfer member 70 is made of a material having a thermal conductivity higher than, for example, those of the base plate 41, the base plate 51, and the intermediate board 60. However, the heat transfer member 70 is not limited to the above example, and may be a heat transfer member made of a thermally conductive gel or other materials. The heat transfer member 70 is an example of a “first heat transfer member”.

The heat transfer member 70 has a plate shape formed in the X direction and the Y direction. The heat transfer member 70 is sandwiched between the bus bar 42 and the bus bar 52, and is in surface contact with and in close contact with the bus bar 42 and the bus bar 52. The heat transfer member 70 faces and is in surface contact with the flat surface of the bus bar 42 on the −Z direction side. The heat transfer member 70 faces and is in surface contact with the flat surface of the bus bar 52 on the +Z direction side.

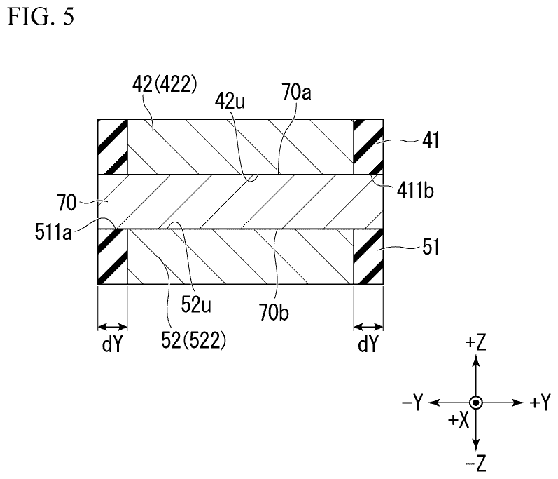

As illustrated in FIG. 5, the heat transfer member 70 has a first contact surface 70a and a second contact surface 70b. The first contact surface 70a is a flat surface directed in the +Z direction. The first contact surface 70a is in surface contact with the flat surface of the bus bar 42 on the −Z direction side over the X direction. The second contact surface 70b is a flat surface located on the side opposite to the first contact surface 70a and directed in the −Z direction. The second contact surface 70b is in surface contact with the flat surface of the bus bar 52 on the +Z direction side over the X direction.

The heat transfer member 70 overlaps at least part of a portion where the bus bar 42 and the bus bar 52 overlap when viewed from the Z direction. For example, the heat transfer member 70 may overlap at least part of a portion where the extending portion 422 and the extending portion 522 overlap when viewed from the Z direction.

For example, the width of the heat transfer member 70 in the Y direction may be equal to a size obtained by adding a width difference dY to both sides of the width of the portion where the extending portion 422 and the extending portion 522 overlap each other in the Y direction or larger than a size obtained by adding the width difference dY to both sides of the width. For example, the width difference dY may be the same as the thickness of the heat transfer member 70 in the Z direction in a state of being in close contact with the bus bar 42 and the bus bar 52. When the heat transfer effect is sufficient, the width of the heat transfer member 70 in the Y direction may be equal to the width of the portion where the extending portion 422 and the extending portion 522 overlap each other in the Y direction, or may be smaller than the width of the overlapping portion in the Y direction.

For example, the length of the heat transfer member 70 in the X direction may be shorter than the length of the portion where the extending portion 422 and the extending portion 522 overlap each other in the X direction. For example, when viewed from the Z direction, the center position of the heat transfer member 70 in the Y direction may coincide with the center position of the portion where the extending portion 422 and the extending portion 522 overlap in the Y direction. For example, the heat transfer member 70 may have the same thickness in the Z direction as the gap in the Z direction between the bus bar 42 and the bus bar 52 in a state of being sandwiched between the bus bar 42 and the bus bar 52 and being in close contact with the bus bar 42 and the bus bar 52. When the heat transfer effect is insufficient, the length of the heat transfer member 70 in the X direction may be the same as the length of the portion where the extending portion 422 and the extending portion 522 overlap each other in the X direction, or may be slightly larger than the length of the overlapping portion in the X direction.

### A11. Metal Plate, Insulating Sheet, Heat Transfer Member, and Insulating Cover

Next, the metal plate 80, the insulating sheet 91, the heat transfer member 92, and the insulating cover 93 will be described.

### <A11.1 Metal Plate>

The metal plate 80 is a member for securing rigidity of the electrical connection unit 1 and enhancing a heat dissipation property of the electrical connection unit 1. The metal plate 80 is made of a metal (for example, aluminum or an aluminum alloy). The metal plate 80 may be referred to as a “rigid member”.

The metal plate 80 has a rectangular shape formed in the X direction when viewed from the Z direction. The metal plate 80 includes a flat surface portion 81.

As illustrated in FIG. 1, the flat surface portion 81 is a portion formed in a plate shape in the metal plate 80. The flat surface portion 81 has a plate shape formed in the horizontal direction. The flat surface portion 81 forms a main portion of the metal plate 80. The flat surface portion 81 forms a base portion (metal base portion) of the metal plate 80. In the present embodiment, the flat surface portion 81 has a size that covers the main body MU from below. The flat surface portion 81 faces the routing board 50. In the present embodiment, the flat surface portion 81 faces the fourth surface 511b of the flat surface portion 511. The electrical connection unit 1 has a gap between the flat surface portion 81 and the fourth surface 511b of the flat surface portion 511. That is, the flat surface portion 81 is provided with a gap between the flat surface portion 81 and the fourth surface 511b of the flat surface portion 511.

### <A11.2 Insulating Sheet>

The insulating sheet 91 is an insulating member for electrically insulating the metal plate 80 from the routing board 50. The insulating sheet 91 is made of, for example, a synthetic resin such as polyester or polyimide, and has an insulating property. The insulating sheet 91 has a rectangular shape when viewed from the Z direction. The insulating sheet 91 has a sheet shape formed in the horizontal direction. The insulating sheet 91 is disposed between the flat surface portion 81 of the metal plate 80 and the routing board 50. For example, the insulating sheet 91 may be disposed between the flat surface portion 81 of the metal plate 80 and the plurality of heat transfer members 92.

In the present embodiment, the insulating sheet 91 is attached to the flat surface portion 81 of the metal plate 80. Note that the insulating sheet 91 may be provided between the routing board 50 and the plurality of heat transfer members 92 instead of the above example. Note that, in a case where the heat transfer member 92 has an insulating property and the necessary insulating property is secured by the heat transfer member 92, the insulating sheet 91 may be omitted.

### <A11.3 Second Heat Transfer Member>

The heat transfer member 92 is a member for transferring heat (Joule heat) generated by the bus bar 42 itself at the time of energization and/or heat (Joule heat) generated by the bus bar 52 itself at the time of energization and/or heat generated by the electronic component 10 at the time of energization to the metal plate 80. The heat transfer member 92 is, for example, a heat transfer sheet (for example, a thermally conductive silicone sheet) having elasticity. The heat transfer member 92 is made of a material having a thermal conductivity higher than those of the base plate 41, the base plate 51, and the intermediate board 60, for example. However, the heat transfer member 92 is not limited to the above example, and may be a heat transfer member made of a thermally conductive gel or other materials. The heat transfer member 92 is an example of a “second heat transfer member”.

In the present embodiment, the plurality of heat transfer members 92 are partially provided in the routing board 50. For example, each heat transfer member 92 is disposed to be in contact with the bus bar 52 at a position overlapping part of the bus bar 52 when viewed from the Z direction. Furthermore, each of the heat transfer members 92 is disposed at part of a position where part of the bus bar 42, the heat transfer member 70, and part of the bus bar 52 overlap when viewed from the Z direction. In this case, the heat of the bus bar 42 is easily transferred to the metal plate 80 via the heat transfer member 70, the bus bar 52, and the heat transfer member 92.

### <A11.4 Insulating Cover>

The insulating cover 93 will be described. The insulating cover 93 is a member for preventing the main body MU from contacting the energization path. The insulating cover 93 is made of, for example, a synthetic resin and has an insulating property. The insulating cover 93 has, for example, a box shape that is open on the −Z direction side. The insulating cover 93 has a plurality of vent holes 93h. The insulating cover 93 is attached to the metal plate 80 in the Z direction. Note that the insulating cover 93 is not limited to a box-shaped member, and may be a sheet-shaped member that covers the energization path of the main body MU.

### A12. Exposure Structure of Bus Bar

Next, an exposure structure of the bus bar 42 and the bus bar 52 will be described in detail.

### <A12.1 Exposure Structure of First Bus Bar>

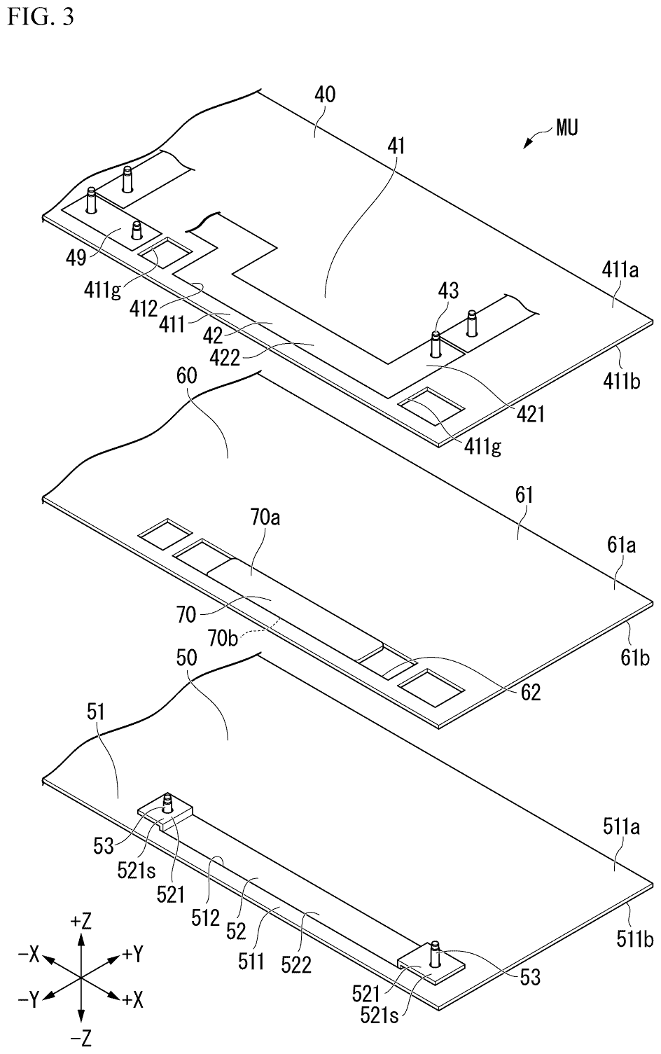

As illustrated in FIG. 3, in the present embodiment, at least part of the extending portion 422 of the bus bar 42 is exposed to the outside of the base plate 41 on the upper surface side (the first surface 411a side of the flat surface portion 411). For example, at least part of the extending portion 422 of the bus bar 42 may be exposed to the outside of the base plate 41 on the upper surface side.

For example, the bus bar 42 may be accommodated in the accommodation portion 412 at least from the connection portion 421 over the entire length of the extending portion 422 and may extend along the first surface 411a of the flat surface portion 411. For example, the bus bar 42 may be exposed to the outside of the base plate 41 on the upper surface side at least over the entire length of the extending portion 422 from the connection portion 421.

For example, the bus bar 42 may be accommodated in the accommodation portion 412 over the entire length of the bus bar 42 and extend along the first surface 411a of the flat surface portion 411. For example, the bus bar 42 is exposed to the outside of the base plate 41 on the upper surface side over the entire length of the bus bar 42.

For example, at least part of the extending portion 422 of the bus bar 42 may be exposed to the outside of the base plate 41 not only on the upper surface side but also on the lower surface side (second surface 411b side). For example, the bus bar 42 is exposed to the outside of the base plate 41 on the lower surface side over the entire length of the bus bar 42.

### <A12.2 Exposure Structure on Lower Surface Side of First Bus Bar>

As illustrated in FIG. 5, in the present embodiment, the extending portion 422 of the bus bar 42 includes an exposed portion 42u exposed to the outside of the base plate 41 on the lower surface side (the second surface 411b side of the flat surface portion 411). In the present embodiment, the exposed portion 42u of the bus bar 42 extends over the entire length of the bus bar 42. In the present embodiment, the heat transfer member 70 is disposed on the exposed portion 42u of the bus bar 42. For example, the heat transfer member 70 is in contact with the exposed portion 42u of the bus bar 42.

As described above, at least part of the extending portion 422 of the bus bar 42 may be exposed to the outside of the base plate 41 not only on the lower surface side but also on the upper surface side (first surface 411a side). For example, the bus bar 42 may be exposed to the outside of the base plate 41 on the upper surface side over the entire length of the bus bar 42. For example, at least part of the extending portion 422 of the bus bar 42 may be covered with the base plate 41 on the upper surface side.

### <A12.3 Exposure Structure of Second Bus Bar>

In the present embodiment, at least part of the extending portion 522 of the bus bar 52 is exposed to the outside of the base plate 51 on the lower surface side (the fourth surface 511b side of the flat surface portion 511). As illustrated in FIG. 3, for example, at least part of the extending portion 522 of the bus bar 52 may be exposed to the outside of the base plate 51 on the upper surface side.

For example, the bus bar 52 may be accommodated in the accommodation portion 512 at least over the entire length of the extending portion 522 and extend along the third surface 511a of the flat surface portion 511. For example, the bus bar 52 may be exposed to the outside of the base plate 51 on the upper surface side at least over the entire length of the extending portion 522.

For example, the bus bar 52 may be accommodated in the accommodation portion 512 over the entire length of the bus bar 52 and extend along the third surface 511a of the flat surface portion 511. For example, the bus bar 52 may be exposed to the outside of the base plate 51 on the lower surface side over the entire length of the bus bar 52.

For example, at least part of the extending portion 522 of the bus bar 52 may be exposed to the outside of the base plate 51 not only on the lower surface side but also on the upper surface side (third surface 511a side). For example, the bus bar 52 may be exposed to the outside of the base plate 51 on the lower surface side over the entire length of the bus bar 52.

### <A12.4 Exposure Structure on Lower Surface Side of Second Bus Bar>

As illustrated in FIG. 5, in the present embodiment, the extending portion 522 of the bus bar 52 includes an exposed portion 52u exposed to the outside of the base plate 51 on the upper surface side (the third surface 511a side of the flat surface portion 511). In the present embodiment, the exposed portion 52u of the bus bar 52 extends over the entire length of the bus bar 52. In the present embodiment, the heat transfer member 70 is disposed at the exposed portion 52u of the bus bar 52. For example, the heat transfer member 70 is in contact with the exposed portion 52u of the bus bar 52.

At least part of the extending portion 522 of the bus bar 52 is exposed to the outside of the base plate 51 not only on the upper surface side but also on the lower surface side (fourth surface 511b side). For example, the bus bar 52 is exposed to the outside of the base plate 51 on the lower surface side over the entire length of the bus bar 52. For example, at least part of the extending portion 522 of the bus bar 52 may be covered with the base plate 51 on the lower surface side.

### A13. Advantages

In the present embodiment, the heat transfer member 70 thermally connects the bus bar 42 to the bus bar 52. According to such a constitution, heat is easily exchanged between the bus bar 42 and the bus bar 52. Therefore, the heat dissipation property of an energized bus bar can be improved.

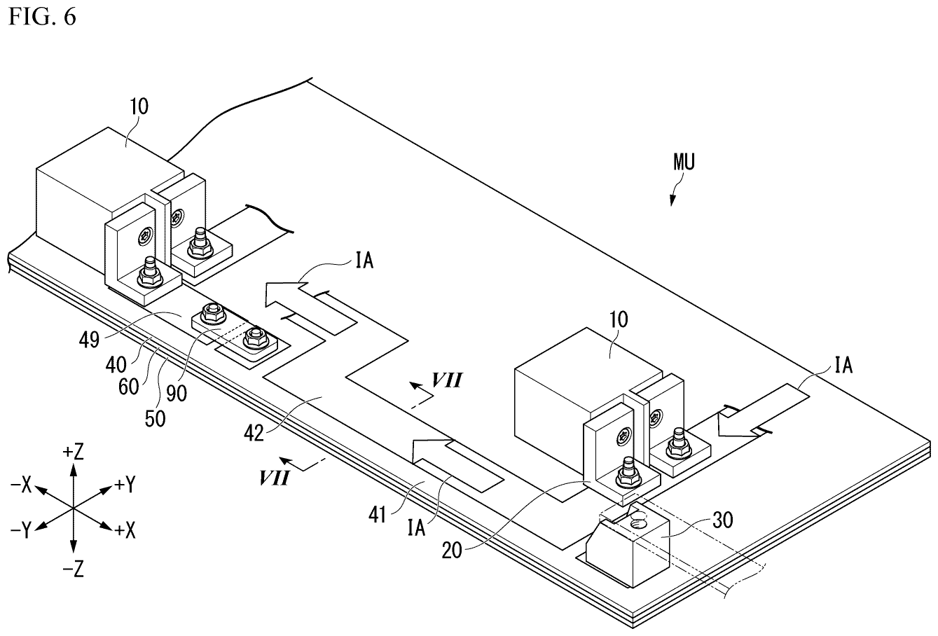

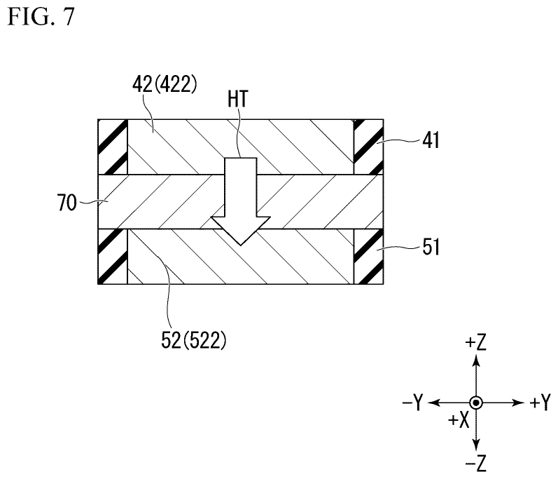

For example, a mode (first operation mode) which is a charging mode in which a current flows from the charger 5 to the battery pack 3 via the electrical connection unit 1 and which is the mode in which the bus bar 42 operates as an energization line during charging and the bus bar 52 operates as a non-energization line will be considered. In this charging mode, as illustrated in FIG. 6, the bus bar 42 is a live bus bar through which a first current IA flows, and the bus bar 52 is a non-live bus bar through which no current flows. As a result of this operation, as illustrated in FIG. 7, heat HT of the bus bar 42 is dissipated to the bus bar 52.

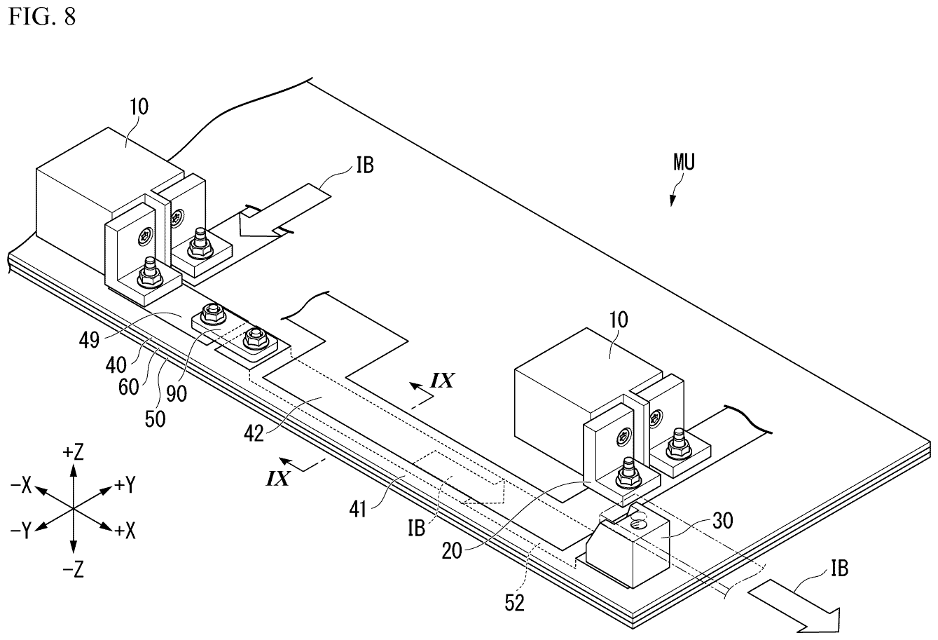

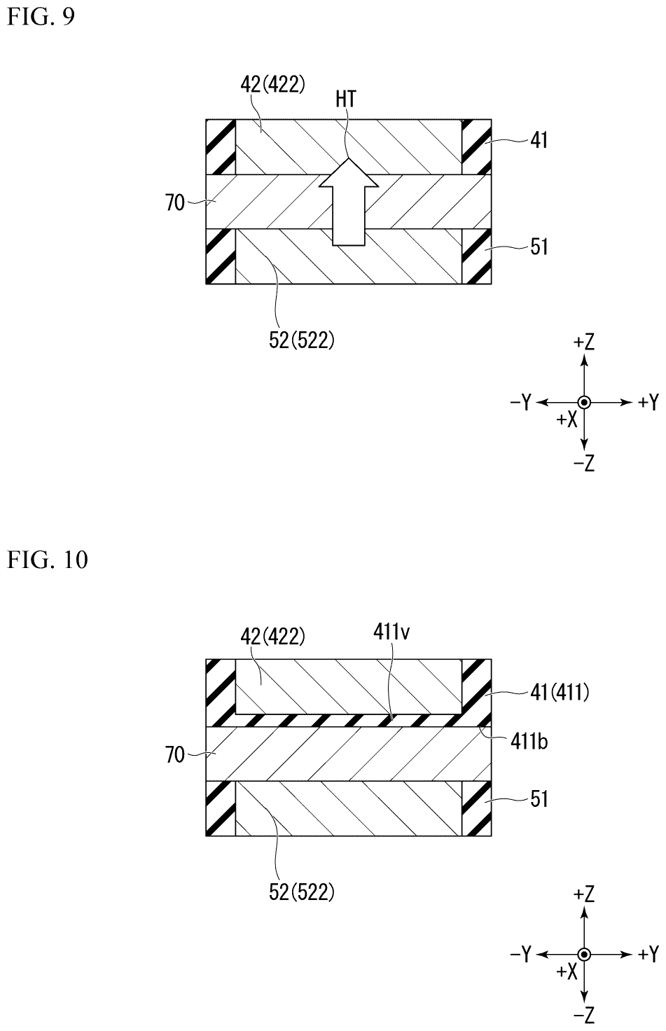

On the other hand, for example, a mode (second operation mode) which is a vehicle traveling mode in which a current flows from the battery pack 3 to the load 4 via the electrical connection unit 1 and which is the mode in which the bus bar 52 operates as an energization line during traveling and the bus bar 42 operates as a non-energization line will be considered. In this vehicle traveling mode, as illustrated in FIG. 8, the bus bar 52 is a live bus bar through which a second current IB flows, and the bus bar 42 is a non-live bus bar through which no current flows. As a result of this operation, as illustrated in FIG. 9, the heat HT of the bus bar 52 is dissipated to the bus bar 42.

As illustrated in FIGS. 6 to 9, when one of the bus bar 42 and the bus bar 52 is a live bus bar and the other is a non-live bus bar, the non-live bus bar can be used as a thermal mass. As a result of this action, the heat dissipation property of the energized bus bar can be improved. Therefore, according to the electrical connection unit 1, it is possible to improve a heat dissipation property.

In the present embodiment, the heat transfer member 70 is disposed between the bus bar 42 and the bus bar 52. According to such a constitution, heat is more easily exchanged between the bus bar 42 and the bus bar 52. Therefore, the heat dissipation property of an energized bus bar can be improved.

In the present embodiment, the first contact surface 70a of the heat transfer member 70 is in surface contact with the bus bar 42 over the X direction. On the other hand, the second contact surface 70b of the heat transfer member 70 is in surface contact with the bus bar 52 over the X direction. According to this constitution, the cross-sectional area of the heat transfer path can be increased. Therefore, according to the electrical connection unit 1, the heat dissipation property of an energized bus bar can be improved.

In the present embodiment, the accommodation portion 62 of the intermediate board 60 disposed between the routing board 40 and the routing board 50 accommodates the heat transfer member 70. According to such a constitution, it is easy to dispose the heat transfer member 70. For example, according to such a constitution, it is easy to dispose the heat transfer member 70 at a position where the heat transfer member 70 can be brought into surface contact with the bus bar 42 and the bus bar 52. Therefore, the heat dissipation property of an energized bus bar can be improved. Furthermore, if the heat transfer member 70 is easily disposed, the electrical connection unit 1 can be easily assembled.

In the present embodiment, in the first operation mode, the electrical connection unit 1 can cause the first current IA that is a current flowing only to the bus bar 42 to flow out of the bus bar 52 and the bus bar 42. In the second operation mode, the electrical connection unit 1 can cause the second current IB that is a current flowing only to the bus bar 52 to flow out of the bus bar 42 and the bus bar 52. According to these constitutions, in the first operation mode, Joule heat generated in the bus bar 42 is dissipated to the bus bar 52. In the second operation mode, Joule heat generated in the bus bar 52 is dissipated to the bus bar 42. Therefore, according to the electrical connection unit 1, the heat dissipation property of an energized bus bar can be improved.

In the present embodiment, the first current IA is a charging current for the battery pack 3. In the present embodiment, the second current IB is a load current for the load. According to these constitutions, the electrical connection unit 1 can dissipate heat generated in an energized bus bar at the time of charging and load driving to a non-energized bus bar. Therefore, according to the electrical connection unit 1, the heat dissipation property of an energized bus bar can be improved.

In the present embodiment, the heat transfer member 92 is disposed between the second bus bar and the metal plate 80. According to this constitution, the electrical connection unit 1 can dissipate heat generated in an energized bus bar to the metal plate 80. Therefore, according to the electrical connection unit 1, the heat dissipation property of an energized bus bar can be improved.

### A14. Modification Examples

Next, several modification examples will be described. Note that a constitution other than those described below in each modification example is the same as the constitution of the above-described embodiment.

### First Modification Example

The routing board 40 is not limited to a structure in which the base plate 41 and the bus bar 42 are integrated through insert molding. For example, the bus bar 42 may be disposed in the accommodation portion 412 after the base plate 41 provided with the accommodation portion 412 for accommodating the bus bar 42 is molded. In this case, the bus bar 42 may be fixed to the accommodation portion 412 through fitting, or may be fixed to the accommodation portion 412 via an adhesive or other fixing means. In these cases, potting may be performed to fill a gap between the bus bar 42 and the accommodation portion 412.

### Second Modification Example

A base member of the routing board 40 is not limited to the base plate 41 having the plate-shaped flat surface portion 411. The routing board 40 may be a base member (for example, an insulating sheet) having the sheet-shaped flat surface portion 411. In this case, the accommodation portion 412 may be formed by part of the flat surface portion 411 following the outer shape of the bus bar 42.

### Third Modification Example

The routing board 50 is not limited to a structure in which the base plate 51 and the bus bar 52 are integrated through insert molding. For example, the bus bar 52 may be disposed in the accommodation portion 512 after the base plate 51 provided with the accommodation portion 512 for accommodating the bus bar 52 is molded. In this case, the bus bar 52 may be fixed to the accommodation portion 512 through fitting, or may be fixed to the accommodation portion 512 via an adhesive or other fixing means. In these cases, potting may be performed to fill a gap between the bus bar 52 and the accommodation portion 512.

### Fourth Modification Example

A base member of the routing board 50 is not limited to the base plate 51 having the plate-shaped flat surface portion 511. The routing board 50 may be a base member (for example, an insulating sheet) having a sheet-shaped flat surface portion 511. In this case, the accommodation portion 512 may be formed by part of the flat surface portion 511 following the outer shape of the bus bar 52.

### Fifth Modification Example

As illustrated in FIG. 10, as a modification example, the flat surface portion 411 of the base plate 41 may have a cover portion 411v that covers at least part of the extending portion 422 of the bus bar 42 on the lower surface side (second surface 411b side). In a region covered by the cover portion 411v, the bus bar 42 is not exposed to the heat transfer member 70 on the lower surface. The cover portion 411v may be provided over the entire length of the bus bar 42. Note that the cover portion 411v need not be provided, for example, in a region overlapping the heat transfer member 92 when viewed from the Z direction.

### Sixth Modification Example

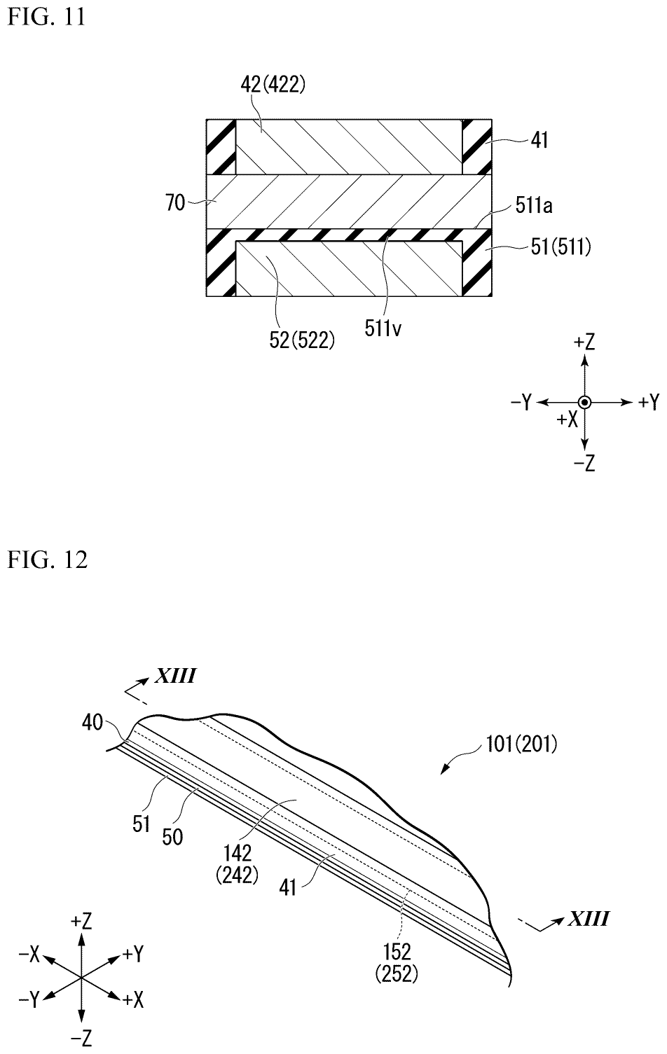

As illustrated in FIG. 11, as a modification example, the flat surface portion 511 of the base plate 51 may have a cover portion 511v that covers at least part of the extending portion 522 of the bus bar 52 on the upper surface side (third surface 511a side). In a region covered by the cover portion 511v, the bus bar 52 is not exposed to the heat transfer member 70 on the upper surface. The cover portion 511v may be provided over the entire length of the bus bar 52. Note that the cover portion 511v need not be provided, for example, in a region overlapping the heat transfer member 92 when viewed from the Z direction.

### Seventh Modification Example

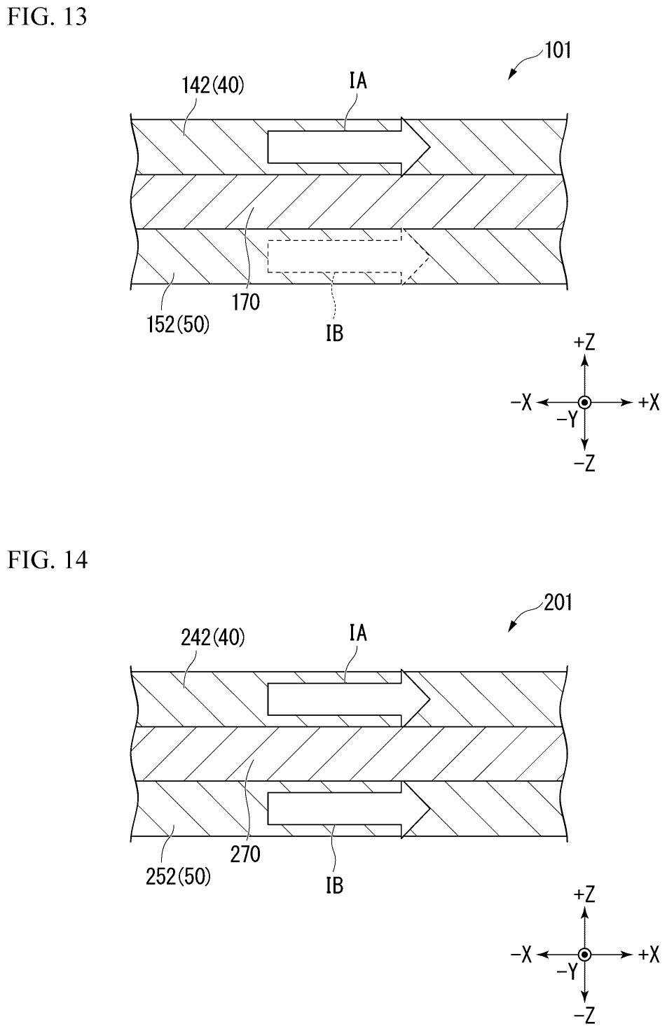

In the above-described embodiment, in the electrical connection unit 1, the first current IA is a charging current for the battery pack 3, and the second current IB is a load current. However, the first current IA and the second current IB may be any current as long as heat can be exchanged between the bus bars. As in an electrical connection unit 101 illustrated in FIGS. 12 and 13, as the seventh modification example, the first current IA may be a current flowing through a bus bar 142 included in the routing board 40. In addition, as the seventh modification example, the second current IB may be a current flowing through a bus bar 152 included in the routing board 50. The bus bar 142 is held by the base plate 41. The bus bar 152 is held by the base plate 51. A heat transfer member 170 is sandwiched between the bus bar 142 and the bus bar 152, and is in surface contact with and in close contact with the bus bar 142 and the bus bar 152. The bus bar 142 is an example of a “first bus bar”. The bus bar 152 is an example of a “second bus bar”. The heat transfer member 170 is an example of a “first heat transfer member”.

For example, in the first operation mode in the present modification example, a current flowing through a plurality of batteries 31 connected in parallel may flow through the bus bar 142 as the first current IA. Here, in the first operation mode in the present modification example, it is possible to cause a current to flow only to the bus bar 142 out of the bus bar 142 and the bus bar 152.

For example, in the second operation mode in the present modification example, a current flowing through the plurality of batteries 31 connected in series may flow through the bus bar 152 as the second current IB. Here, in the second operation mode in the present modification example, it is possible to cause a current to flow only to the bus bar 152 out of the bus bar 142 and the bus bar 152.

Also in such a seventh modification example, since one of the bus bar 142 and the bus bar 152 is a live bus bar and the other is a non-live bus bar, the non-live bus bar can be used as a thermal mass. As a result of this action, the heat dissipation property of the energized bus bar can be improved. Therefore, according to the electrical connection unit 101, the heat dissipation property can be improved.

### Eighth Modification Example

In the above-described embodiment, in the electrical connection unit 1, the first current IA is a charging current for the battery pack 3, and the second current IB is a load current. However, the first current IA and the second current IB may be any current as long as heat can be exchanged between the bus bars. As in an electrical connection unit 201 illustrated in FIGS. 12 and 14, as the eighth modification example, the first current IA may be a current flowing through a bus bar 242 included in the routing board 40. In addition, as the eighth modification example, the second current IB may be a current flowing through a bus bar 252 included in the routing board 50. The bus bar 242 is held by the base plate 41. The bus bar 252 is held by the base plate 51. A heat transfer member 270 is sandwiched between the bus bar 242 and the bus bar 252, and is in surface contact with and in close contact with the bus bar 242 and the bus bar 252. The bus bar 242 is an example of a “first bus bar”. The bus bar 252 is an example of a “second bus bar”. The heat transfer member 270 is an example of a “first heat transfer member”.

For example, in the present modification example, in one operation mode, the first current IA may flow through the bus bar 242, and the second current IB may flow through the bus bar 252.

For example, in this one operation mode in the present modification example, a current smaller than the first current IA or a current larger than the first current IA may flow through the bus bar 252 as the second current IB.

Also in such an eighth modification example, out of the bus bars 242 and 252, a bus bar having a large flowing current can use a bus bar having a small flowing current as a thermal mass. As a result of this action, the heat dissipation property of the energized bus bar can be improved. Therefore, according to the electrical connection unit 201, the heat dissipation property can be improved.

### Ninth Modification Example

In the above-described embodiment, the bus bar 52 is connected to the connection component 30. However, the bus bar 52 need not be connected to the connection component 30 as long as heat can be exchanged between the bus bar 42 and the bus bar 52.

### Tenth Modification Example

In the above-described embodiment, the bus bar 52 is connected to the connection component 90. However, the bus bar 52 need not be connected to the connection component 90 as long as heat can be exchanged between the bus bar 42 and the bus bar 52.

### B. Second Embodiment

An electrical connection unit 301 of a second embodiment is different from the electrical connection unit 1 of the first embodiment in that a heat transfer member 270 is provided as a constitution for exchanging heat between a bus bar and a bus bar. The constitution of the electrical connection unit 301 other than that described below is the same as the constitution of the electrical connection unit 1 of the first embodiment.

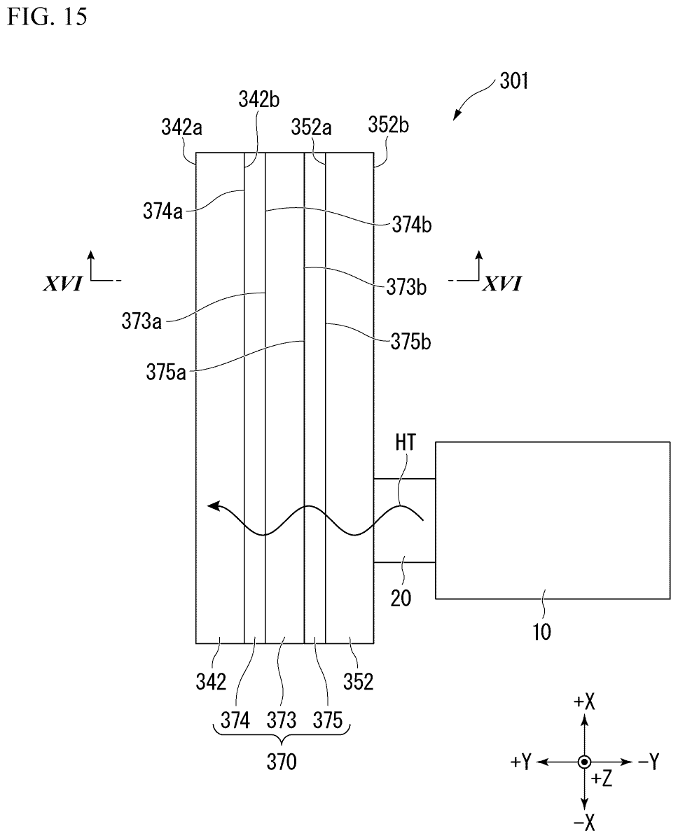

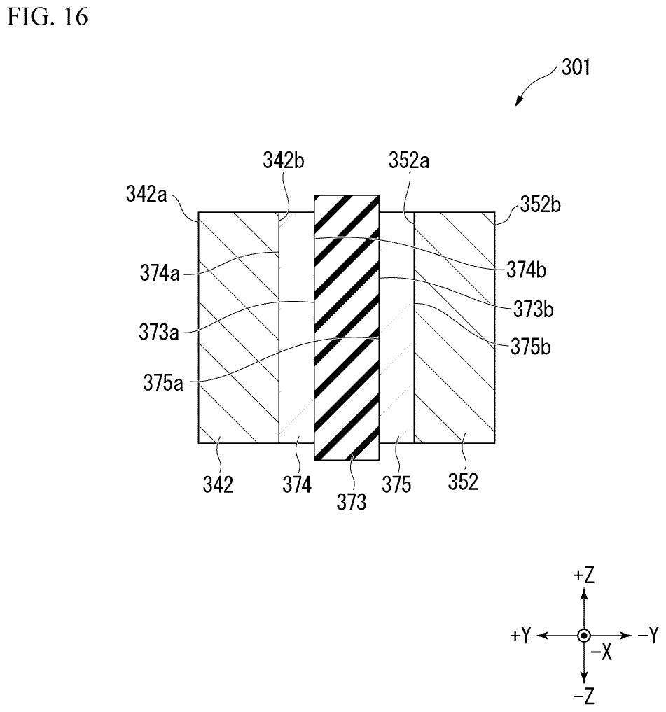

In the present embodiment, as illustrated in FIGS. 15 and 16, the electrical connection unit 301 includes an electronic component 10, a connection component 20, a bus bar 342, a bus bar 352, and a heat transfer member 370. The heat transfer member 370 is sandwiched between the bus bar 342 and the bus bar 352, and is in surface contact with and in close contact with the bus bar 342 and the bus bar 352. The bus bar 342 is an example of a “first bus bar”. The bus bar 352 is an example of a “second bus bar”. The heat transfer member 370 is an example of a “first heat transfer member”.

### B1. Electronic Component

First, the electronic component 10 will be described.

The electronic component 10 is an electronic component mounted according to a function required for the main body MU. The electronic component 10 is, for example, a connector, a fuse, a relay (for example, a mechanical relay or a semiconductor relay), a capacitor, a branch component, any of various sensors (for example, a current sensor or a voltage sensor), an electronic control unit, or an electronic component unit in which two or more of these are unitized. Note that the type of the electronic component 10 is not limited to the above example. For example, the electronic component 10 may be, for example, a heat generating component that generates heat when energized.

### B2. Connection Component for Component Connection

Next, the connection component 20 will be described.

The connection component 20 is a component that electrically connects the electronic component 10 to the main body MU. The connection component 20 forms part of an energization path in the main body MU. In the present embodiment, the connection component 20 is a component that electrically connects the electronic component 10 to the bus bar 352. The connection component 20 is made of a metal (for example, copper or a copper alloy). The electronic component 10 and the connection component 20 are in contact with each other. The bus bar 352 and the connection component 20 are in contact with each other. (A connection terminal of) the electronic component 10 and the connection component 20 may be fastened to each other via a fastening member such as a screw or a bolt. The electronic component 10 and the bus bar 352 may be fastened to each other via a fastening member such as a screw or a bolt.

### B3. First Bus Bar and Second Bus Bar

Next, the bus bar 342 and the bus bar 352 will be described.

Each of the bus bars 342 and 352 extends in the X direction. Each of bus bar 342 and bus bar 352 is made of a metal (for example, copper or a copper alloy), and has conductivity. The bus bar 342 and the bus bar 352 include portions disposed on the same plane. For example, a current similar to that of the bus bar 42 of the first embodiment may flow through the bus bar 342. For example, a current similar to that of the bus bar 52 of the first embodiment may flow through the bus bar 352.

At least part of the bus bar 342 has a first bus bar surface 342a and a second bus bar surface 342b as a pair of plate surfaces. The first bus bar surface 342a is directed in the +Y direction. The second bus bar surface 342b is directed in the −Y direction.

At least part of the bus bar 352 has a third bus bar surface 352a and a fourth bus bar surface 352b as a pair of plate surfaces. The third bus bar surface 352a is directed in the +Y direction. The fourth bus bar surface 352b is directed in the −Y direction. The connection component 20 is in contact with the fourth bus bar surface 352b.

### B4. First Heat Transfer Member

Next, the heat transfer member 370 will be described.

The heat transfer member 370 is a member disposed between the bus bar 342 and the bus bar 352. The heat transfer member 370 is a member for transferring heat between the bus bar 342 and the bus bar 352. For example, the heat transfer member 370 may be a member for transferring heat (Joule heat) generated by the bus bar 342 itself when the bus bar 342 is energized, to the bus bar 352. For example, the heat transfer member 370 may be a member for transferring heat (Joule heat) generated in the bus bar 352 itself when the bus bar 352 is energized, to the bus bar 342. The heat transfer member 370 may be, for example, a member for transmitting heat HT generated in the electronic component 10 when the electronic component 10 is energized, to the bus bar 342 via the bus bar 352.

The heat transfer member 370 overlaps at least part of a portion where the bus bar 342 and the bus bar 352 overlap when viewed from the Y direction. The heat transfer member 370 includes an insulator 373, a first contact member 374, and a second contact member 375. The first contact member 374 is in contact with the bus bar 342 and the insulator 373. The second contact member 375 is in contact with the bus bar 352 and the insulator 373.

The insulator 373 is made of, for example, a synthetic resin and has an electrical insulating property. The insulator 373 electrically insulates the bus bar 342 from the bus bar 352. For example, the insulator 373 may be made of a material having an electrical resistivity higher than that of each of the first contact member 374 and the second contact member 375. The insulator 373 may have, for example, a heat transfer property. The insulator 373 has a plate shape formed in the Z direction and the X direction. The insulator 373 has a shape extending longer in the X direction than in the Z direction. The insulator 373 may protrude more in the +Z direction and the −Z direction than the first contact member 374 and the second contact member 375, respectively.

The insulator 373 has a first heat transfer surface 373a and a second heat transfer surface 373b as a pair of plate surfaces. The insulator 373 has an insulating property between the first heat transfer surface 373a and the second heat transfer surface 373b. The insulator 373 can transfer heat between the first heat transfer surface 373a and the second heat transfer surface 373b. The first heat transfer surface 373a is a surface directed in the +Y direction. The second heat transfer surface 373b is a surface directed in the −Y direction. Each of the first heat transfer surface 373a and the second heat transfer surface 373b may be, for example, a flat surface.

The first contact member 374 is interposed between the insulator 373 and the bus bar 342. The first contact member 374 is, for example, a heat transfer sheet (for example, a thermally conductive silicone sheet) having elasticity. For example, the first contact member 374 may be made of a material having thermal conductivity higher than that of the insulator 373. However, the first contact member 374 is not limited to the above example, and may be a heat transfer member made of a thermally conductive gel or other materials. The first contact member 374 may have, for example, an electrical insulating property. The first contact member 374 has a plate shape formed in the Z direction and the X direction. The first contact member 374 has a shape extending longer in the X direction than in the Z direction.

The first contact member 374 has a third heat transfer surface 374a and a fourth heat transfer surface 374b as a pair of heat transfer surfaces. The first contact member 374 can transfer heat between the third heat transfer surface 374a and the fourth heat transfer surface 374b. For example, the first contact member 374 may have an insulating property between the third heat transfer surface 374a and the fourth heat transfer surface 374b. The third heat transfer surface 374a is a surface directed in the +Y direction. The fourth heat transfer surface 374b is a surface directed in the −Y direction. The third heat transfer surface 374a is in surface contact with the second bus bar surface 342b. The third heat transfer surface 374a may be continuously in close contact with the second bus bar surface 342b in the X direction, for example. The fourth heat transfer surface 374b is in surface contact with the first heat transfer surface 373a. The fourth heat transfer surface 374b may be continuously in close contact with the first heat transfer surface 373a in the X direction, for example. The third heat transfer surface 374a is an example of a first contact surface of the heat transfer member 370.

The second contact member 375 is interposed between the insulator 373 and the bus bar 352. The second contact member 375 is, for example, a heat transfer sheet (for example, a thermally conductive silicone sheet) having elasticity. For example, the second contact member 375 may be made of a material having thermal conductivity higher than that of the insulator 373. However, the second contact member 375 is not limited to the above example, and may be a heat transfer member made of a thermally conductive gel or other materials. The second contact member 375 may have, for example, an electrical insulating property. The second contact member 375 has a plate shape formed in the Z direction and the X direction. The second contact member 375 has a shape extending longer in the X direction than in the Z direction.

The second contact member 375 has a fifth heat transfer surface 375a and a sixth heat transfer surface 375b as a pair of heat transfer surfaces. The second contact member 375 can transfer heat between the fifth heat transfer surface 375a and the sixth heat transfer surface 375b. For example, the second contact member 375 may have an insulating property between the fifth heat transfer surface 375a and the sixth heat transfer surface 375b. The fifth heat transfer surface 375a is a surface directed in the +Y direction. The sixth heat transfer surface 375b is a surface directed in the −Y direction. The fifth heat transfer surface 375a is in surface contact with the second heat transfer surface 373b. The fifth heat transfer surface 375a may be continuously in close contact with the second heat transfer surface 373b in the X direction, for example. The sixth heat transfer surface 375b is in surface contact with the third bus bar surface 352a. The sixth heat transfer surface 375b may be continuously in close contact with the third bus bar surface 352a in the X direction, for example. The sixth heat transfer surface 375b is an example of a second contact surface of the heat transfer member 370.

### B5. Advantages

In the present embodiment, similarly to the first embodiment, the heat transfer member 370 thermally connects the bus bar 342 to the bus bar 352. According to such a constitution, heat is easily exchanged between the bus bar 342 and the bus bar 352. Therefore, the heat dissipation property of an energized bus bar can be improved.

In addition, in the present embodiment, the first contact member 374 is in contact with the bus bar 342 and the insulator 373. Further, the second contact member 375 is in contact with the bus bar 352 and the insulator 373. With this constitution, heat is exchanged transferred between the bus bar 342 and the bus bar 352 with the insulator 373 interposed therebetween.

As a comparative example, in a case where a member interposed between the first bus bar and the second bus bar is only an insulator, a temperature difference is likely to occur between a first bus bar not connected to an electronic component and a second bus bar connected to the electronic component. Due to this temperature difference, the temperature of the second bus bar becomes higher than that of the first bus bar, and for example, an allowable current of the second bus bar may be limited. As a result, in the comparative example, the second bus bar may become a bottleneck at the time of energization.

In contrast to such a comparative example, in the electrical connection unit 301 of the present embodiment, the bus bar 342 and the bus bar 352 are easily leveled to the same temperature, for example, by the above-described constitution. In addition, as illustrated in FIG. 15, according to the electrical connection unit 301 of the present embodiment, the heat HT transferred from the electronic component 10, which is a heat generation body, to the bus bar 352 connected to the electronic component 10 is easily transferred to the bus bar 342. Through this action, the bus bar 352 is easily cooled. Therefore, the bus bar 352 is less likely to become a bottleneck at the time of energization.

### Modification Example

In the second embodiment described above, the plate surfaces of the bus bars 342 and 352 and the contact surfaces of the heat transfer members 370 are directed in the Y direction. However, the heat transfer member 370 may have any constitution as long as the heat transfer member 370 thermally connects the bus bar 342 to the bus bar 352. As a modification example, as in the first embodiment, the plate surfaces of the bus bar 342 and the bus bar 352 and the contact surfaces of the heat transfer member 370 may be directed in the Z direction. In this case, for example, the bus bar 342 may be held by the flat surface portion 411 of the base plate 41 by being accommodated in the accommodation portion 412 of the base plate 41 similar to that of the first embodiment. For example, the bus bar 352 may be held by the flat surface portion 511 of the base plate 51 by being accommodated in the accommodation portion 512 of the base plate 51 similar to that of the first embodiment. In addition, the heat transfer member 370 may be held by the flat surface portion 61 of the intermediate board 60 by being accommodated in the accommodation portion 62 of the intermediate board 60 similar to the first embodiment, for example. Even with such a modification example, the heat dissipation property of an energized bus bar can be improved.

### C. Third Embodiment

An electrical connection unit 401 of a third embodiment is the electrical connection unit 301 of the second embodiment, and further includes a constitution capable of dissipating heat of a bus bar to a ferrite core. A constitution of the electrical connection unit 401 other than that described below is the same as the constitution of the electrical connection unit 301 of the second embodiment.

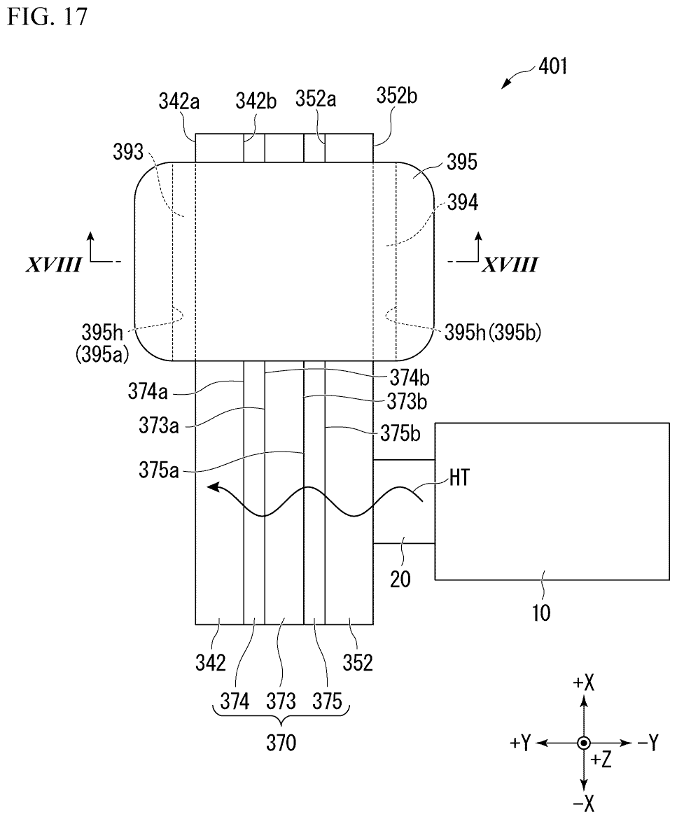

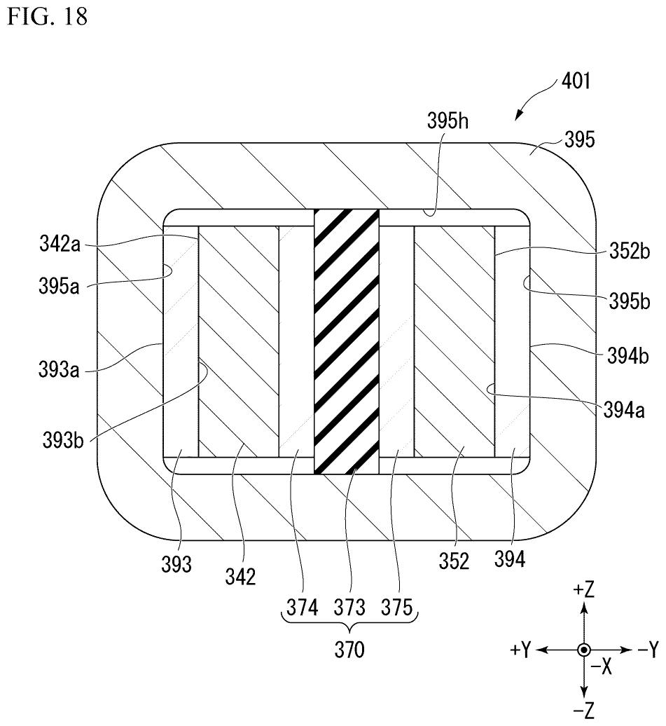

In the present embodiment, as illustrated in FIGS. 17 and 18, the electrical connection unit 401 includes an electronic component 10, a connection component 20, a bus bar 342, a bus bar 352, a heat transfer member 370, a heat transfer member 393, a heat transfer member 394, and a ferrite core 395. The bus bar 342 and the bus bar 352 pass through the ferrite core 395. The heat transfer member 393 thermally connects the bus bar 342 to the ferrite core 395. The heat transfer member 394 thermally connects the bus bar 352 to the ferrite core 395. The heat transfer member 393 is an example of a “first assistance member”. The heat transfer member 394 is an example of a “second assistance member”.

### C1. Ferrite Core

The ferrite core 395 is attached to the bus bar 342 and the bus bar 352 for noise removal. For example, in a case where the bus bar 342 and the bus bar 352 are bus bars disposed in parallel near the batteries IN/OUT in a high-voltage component of the electric vehicle, the ferrite core 395 is attached for noise removal between the electrical connection unit 401 and the batteries.

The ferrite core 395 has a through-hole 395h penetrating the ferrite core 395 in the X direction. The ferrite core 395 further includes a first flat surface 395a and a second flat surface 395b. Each of the first flat surface 395a and the second flat surface 395b is part of an inner peripheral surface defining the through-hole 395h. The first flat surface 395a is a flat surface located on the +Y direction side of the inner peripheral surface of the ferrite core 395. The first flat surface 395a is directed in the −Y direction. The second flat surface 395b is a flat surface located on the −Y direction side of the inner peripheral surface of the ferrite core 395. The second flat surface 395b is directed in the +Y direction.

### C2. First Assistance Member

The heat transfer member 393 is a member that assists in heat dissipation of the bus bar 342. The heat transfer member 393 is interposed between the ferrite core 395 and the bus bar 342. The heat transfer member 393 overlaps at least part of a portion where the bus bar 342 and the bus bar 352 overlap when viewed from the Y direction. The heat transfer member 393 is, for example, a heat transfer sheet (for example, a thermally conductive silicone sheet) having elasticity. The heat transfer member 393 may be made of a material having a thermal conductivity higher than that of the insulator 373, for example. However, the heat transfer member 393 is not limited to the above example, and may be a heat transfer member made of a thermally conductive gel or other materials. The heat transfer member 393 may have, for example, an electrical insulating property. The heat transfer member 393 has a plate shape formed in the Z direction and the X direction. For example, the heat transfer member 393 may have the same length as the through-hole 395h in the X direction.

The heat transfer member 393 has a third contact surface 393a and a fourth contact surface 393b as a pair of contact surfaces. The heat transfer member 393 can transfer heat between the third contact surface 393a and the fourth contact surface 393b. For example, the heat transfer member 393 may have an insulating property between the third contact surface 393a and the fourth contact surface 393b. The third contact surface 393a is a surface directed in the +Y direction. The fourth contact surface 393b is a surface directed in the −Y direction. The third contact surface 393a is in surface contact with the first flat surface 395a. The third contact surface 393a may be continuously in close contact with the first flat surface 395a in the Z direction and the X direction, for example. The fourth contact surface 393b is in surface contact with the first bus bar surface 342a. The fourth contact surface 393b may be continuously in close contact with the first bus bar surface 342a in the Z direction and the X direction, for example.

### C3. Second Assistance Member

The heat transfer member 394 is a member that assists in heat dissipation of the bus bar 352. The heat transfer member 394 is interposed between the ferrite core 395 and the bus bar 352. The heat transfer member 394 overlaps at least part of a portion where the bus bar 342 and the bus bar 352 overlap when viewed from the Y direction. The heat transfer member 394 may overlap, for example, the entire heat transfer member 393 when viewed from the Z direction. The heat transfer member 394 is, for example, a heat transfer sheet (for example, a thermally conductive silicone sheet) having elasticity. The heat transfer member 394 may be made of a material having thermal conductivity higher than that of the insulator 373, for example. However, the heat transfer member 394 is not limited to the above example, and may be a heat transfer member made of a thermally conductive gel or other materials. The heat transfer member 394 may have, for example, an electrical insulating property. The heat transfer member 394 has a plate shape formed in the Z direction and the X direction. For example, the heat transfer member 394 may have the same length as the through-hole 395h in the X direction.

The heat transfer member 394 has a fifth contact surface 394a and a sixth contact surface 394b as a pair of contact surfaces. The heat transfer member 394 can transfer heat between the fifth contact surface 394a and the sixth contact surface 394b. For example, the heat transfer member 394 may have an insulating property between the fifth contact surface 394a and the sixth contact surface 394b. The fifth contact surface 394a is a surface directed in the +Y direction. The sixth contact surface 394b is a surface directed in the −Y direction. The fifth contact surface 394a is in surface contact with the fourth bus bar surface 352b. The fifth contact surface 394a may be continuously in close contact with the fourth bus bar surface 352b in the Z direction and the X direction, for example. The sixth contact surface 394b is in surface contact with the second flat surface 395b. The fourth contact surface 393b may be continuously in close contact with the second flat surface 395b in the Z direction and the X direction, for example.

### C4. Advantages

In the present embodiment, similarly to the first embodiment, the heat transfer member 370 thermally connects the bus bar 342 to the bus bar 352. According to such a constitution, heat is easily exchanged between the bus bar 342 and the bus bar 352. Therefore, the heat dissipation property of an energized bus bar can be improved.

In addition, in the present embodiment, the heat transfer member 393 thermally connects the bus bar 342 to the ferrite core 395. The heat transfer member 394 thermally connects the bus bar 352 to the ferrite core 395. With these constitutions, the heat transfer member 393 and the heat transfer member 394 assist in dissipating heat of the bus bar 342 and the bus bar 352 to the ferrite core 395. Therefore, the heat dissipation property of an energized bus bar can be improved.

### Modification Example

In the third embodiment described above, the heat transfer member 370 includes the insulator 373, the first contact member 374, and the second contact member 375. However, the heat transfer member 370 may have any constitution as long as the heat transfer member 393 and the heat transfer member 394 can assist in dissipating heat of the bus bar 342 and the bus bar 352 to the ferrite core 395. As a modification example, the heat transfer member 370 may include at least one of the heat transfer member 393 and the heat transfer member 394 without including the insulator 373. Even with such a modification example, the heat dissipation property of an energized bus bar can be improved.

Several embodiments and modification examples have been described above. However, the embodiment and the modification examples are not limited to the examples described above. For example, a plurality of embodiments may be implemented in combination with each other. The above-described embodiments can be implemented in various other forms, and various additions, omissions, substitutions, and changes can be made without departing from the concept of the present disclosure.

### INDUSTRIAL APPLICABILITY

According to the present disclosure, it is possible to improve the heat dissipation property of the electrical connection unit.

### REFERENCE SIGNS LIST

1 Electrical connection unit
2 External device
3 Battery pack
4 Load
5 Charger
10 Electronic component
20 Connection component
30 Connection component
31 Battery
40 Routing board (first routing board)
41 Base plate (first base member)
42 Bus bar (first bus bar)
42u Exposed portion
43 Fastening member
49 Bus bar
50 Routing board (second routing board)
51 Base plate (second base member)
52 Bus bar (second bus bar)
52u Exposed portion
53 Fastening member
60 Intermediate board
61 Flat surface portion
61a Fifth surface
61b Sixth surface
62 Accommodation portion
70 Heat transfer member (first heat transfer member)
70a First contact surface
70b Second contact surface
80 Metal plate
81 Flat surface portion
90 Connection component
91 Insulating sheet
92 Heat transfer member (second heat transfer member)
93 Insulating cover
93h Vent hole
101 Electrical connection unit
142 Bus bar (first bus bar)
152 Bus bar (second bus bar)
170 Heat transfer member (first heat transfer member)
201 Electrical connection unit
242 Bus bar (first bus bar)
252 Bus bar (second bus bar)
270 Heat transfer member (first heat transfer member)
411 Flat surface portion (first flat surface portion)
411a First surface
411b Second surface
411g Opening
411v Cover portion
412 Accommodation portion
421 Connection portion
422 Extending portion
511 Flat surface portion (second flat surface portion)
511a Third surface
511b Fourth surface
511v Cover portion
512 Accommodation portion
521 Connection portion
521s Connection surface
522 Extending portion
dY Width difference
HT Heat
IA First current
IB Second current
MU Main body
301 Electrical connection unit
342 Bus bar (first bus bar)
342a First bus bar surface
342b Second bus bar surface
352 Bus bar (second bus bar)
352a Third bus bar surface
352b Fourth bus bar surface
370 Heat transfer member (first heat transfer member)
373 Insulator
373a First heat transfer surface
373b Second heat transfer surface
374 First contact member
374a Third heat transfer surface (first contact surface)
374b Fourth heat transfer surface
375 Second contact member
375a Fifth heat transfer surface
375b Sixth heat transfer surface (second contact surface)
393 Heat transfer member (first assistance member)
393a Third contact surface
393b Fourth contact surface
394 Heat transfer member (second assistance member)
394a Fifth contact surface
394b Sixth contact surface
395 Ferrite core
395a First flat surface
395b Second flat surface
395h Through-hole
401 Electrical connection unit

What is claimed is:

1. An electrical connection unit comprising:
a first bus bar;
a second bus bar; and
a first heat transfer member that thermally connects the first bus bar to the second bus bar.

2. The electrical connection unit according to claim 1, further comprising:
a first routing board including an insulating first base member including a first flat surface portion having a plate shape or sheet shape and having a first surface facing an electronic component and a second surface located on a side opposite to the first surface, and the first bus bar held by the first flat surface portion; and
a second routing board including an insulating second base member including a second flat surface portion having a plate shape or sheet shape and having a third surface facing the second surface, and the second bus bar held by the second flat surface portion, wherein
the first heat transfer member is disposed between the first bus bar and the second bus bar.

3. The electrical connection unit according to claim 1, wherein
the first heat transfer member has a first contact surface that is in surface contact with the first bus bar over an extending direction of the first bus bar, and a second contact surface that is located on a side opposite to the first contact surface and is in surface contact with the second bus bar over an extending direction of the second bus bar.

4. The electrical connection unit according to claim 2, further comprising
an intermediate board having an accommodation portion that accommodates the first heat transfer member and is disposed between the first routing board and the second routing board.

5. The electrical connection unit according to claim 1, wherein
in a first operation mode, a first current that is a current flowing only to the first bus bar out of the first bus bar and the second bus bar is allowed to flow, and
in a second operation mode, a second current that is a current flowing only to the second bus bar out of the first bus bar and the second bus bar is allowed to flow.

6. The electrical connection unit according to claim 5, wherein
the electrical connection unit is electrically connectable to a battery pack and a load,
the first current is a charging current for the battery pack, and
the second current is a load current for the load.

7. The electrical connection unit according to claim 5, wherein
the electrical connection unit is electrically connectable to a battery pack including a plurality of batteries,
the first current is a current flowing through the plurality of batteries connected in parallel, and
the second current is a current flowing through the plurality of batteries connected in series.

8. The electrical connection unit according to claim 2, further comprising:
in a case where the second routing board has a fourth surface located on a side opposite to the third surface,
a metal plate facing the fourth surface; and
a second heat transfer member disposed between the second bus bar and the metal plate.

9. The electrical connection unit according to claim 1, wherein
the first heat transfer member includes
an insulator that is disposed between the first bus bar and the second bus bar,
a first contact member that is in contact with the first bus bar and the insulator, and
a second contact member that is in contact with the second bus bar and the insulator.

10. The electrical connection unit according to claim 1, further comprising:
a ferrite core that the first bus bar and the second bus bar penetrate;
a first assistance member that thermally connects the first bus bar to the ferrite core; and
a second assistance member that thermally connects the second bus bar to the ferrite core.
